(19) United States
(12) Patent Application Publication
(10) Pub. No.: US 2003/0146588 A1
(43) Pub. Date: Aug. 7, 2003

(54) Swivelable mount for attaching a binding to a snowboard

(76) Inventor: Jon Fiebing, Carlsbad, CA (US)

Correspondence Address: CALIF KIP TERVO, 6387 CAMINITO LAZARO, SAN DIEGO, CA, 92111, US

(21) Appl. No.: 10/066,382

(22) Filed: Feb. 1, 2002

(51) Int. Cl. B62B 13/00

(52) U.S. Cl. 280/14.24; 280/611

(57) ABSTRACT

Mount 10 for attaching a boot binding 120 to a snowboard 100 allows free swiveling of binding 120 in a plane parallel to the deck of snowboard 100. Mount 10 includes a swivel assembly 20 with an upper face 8 for attaching a boot binding 120, a lower face 5 for attaching a snowboard, and cant disk 60 for canting boot binding 120 to an angle non-parallel to the deck of snowboard 100.

### FIELD OF THE INVENTION

This invention relates to a mount for attaching boot bindings to a snowboard, and more particularly to a mount that allows the binding to swivel freely while lifting the binding at a comfortable cant angle.

### BACKGROUND OF THE INVENTION

Snowboards are a type of sportboard used for sliding downhill on snow, propelled by gravity. Since about 1980, snowboards have evolved as hybrids of skis and skateboards. The typical snowboard in use in 2002 is similar to an enlarged skateboard with turned up ends and a smooth undersurface. There are no trucks or wheels, so the snowboard is steered by the rider by shifting the weight to dig one edge of the board into the snow more than the other edge, causing the swowboard to turn. To make a sharper turn, weight is shifted front to back, deweighting one end and allowing the other end to be pivoted.

The snowboard is typically fixed to the rider's feet by bindings that clamp or enclose the rider's boots, similarly to the boot and binding combination used for skiing. Bindings are necessary because snowboarders, like skiers, wear heavy boots that keep the feet warm and allow walking in deep snow.

Skateboarders do not need bindings because they typically wear soft, light shoes with rubber soles that stick to the skateboard. Also, a skateboard pivots easily on its trucks and does not need much force to steer it.

Because a snowboard has to support the rider's weight over snow, including soft deep powder, the snowboard has at least two or three times the area of a normal skateboard. This larger board requires more force and more exaggerated weight shifts in order to steer it than are needed for a skateboard. Relatively rigid soles on the boots worn helps transmit pivoting forces from the feet to the board. Boots and bindings that extend above the snowboarder's ankles allow the stronger muscles of the legs to pivot the board, instead of requiring the snowboarder to use only the ankles for steering.

Standard snowboard bindings attach the rider's boots generally transverse the snowboard, frequently with the toes slightly toward the nose of the board. There are adjustable bindings in use that let the snowboarder rotate the binding in a plane parallel to the plane of the snowboard. Adjustable bindings let the user adapt the angle of the bindings, and hence the feet, relative to the board to suit the user's preference and skill level. These bindings have various locking means that are unlocked to allow rotation of the binding, then are locked to prevent rotation during riding. U.S. Pat. No. 5,915,718 of Dodge is an example of a rotatably adjustable binding.

Duggan (U.S. Pat. No. 6,257,614) teaches that pivoting the ankles and feet while the snowboard is in motion is useful and allows the rider to perform maneuvers that are impractical with locked down bindings. Duggan discloses pivotable bindings for sportboards that are tied in synchrony by a belt or other drive means. Duggan teaches, “Essentially both feet must pivot at the same time and in the same direction . . . Drive belt 70 maintains rotational timing between the rider's feet to prevent a foot ‘stance misalignment’ which might cause injury to the rider and/or loss of control of the sportingboard.”

Prior art thus teaches that the ability to vary the angle of the feet on a snowboard is useful, but must be strictly limited in order to maintain control of the board.

Dodge further teaches that inserting a cant/lift between the binding and the board to tilt the rider's feet toward each other puts “the rider's knees into an ‘A’ configuration which some riders find to be a particularly powerful stance.” The Dodge patent discloses a cant/lift that maintains the desired “A” configuration when the binding is rotated on the board.

Prior art allows for differing preferences for foot position and cant among riders, but requires the rider to lock in the preferred setting before a run, if not before even arriving at the snowboarding slope.

### SUMMARY OF THE INVENTION

The present invention is a mount for connecting a binding to a snowboard in a manner that allows for free and dynamic motion of the legs, ankles, and feet. The mount of the present invention has been found to allow a skilled snowboarder to execute tighter turns than with prior art bindings, to reverse direction more easily, to spin 360° parallel to the snow surface from a standstill, and to maneuver through terrain not accessible to prior art snowboards.

The mount of the present invention is used by attaching the lower face of the mount to a snowboard and attaching the upper face to a standard binding. Usually, a pair of mounts is used to attach a pair of bindings to the board. Each mount includes a swivel assembly that swivels freely and independently of the other mount of the pair. The rider can vary his or her stance continuously, as desired.

The mount includes a cant disk for canting the feet relative to the surface of the snowboard. The cant disk is a disk generally the same diameter as the swivel assembly, with a thickness that increases linearly across the diameter of the disk. It is typically oriented such that the thinnest part of the disk is below the arch of the rider's foot and the thickest part of the disk is near the outer edge of the foot.

The total thickness of the mount is such that the foot may be swiveled freely in a circle without the toe or other part of the boot contacting the snowboard.

The cant disk may be disposed under the swivel assembly, resulting in canting of the axis of rotation of the swivel assembly away from vertical, or the disk may be disposed above the swivel assembly, in which case the axis of rotation is vertical and perpendicular to the longitudinal axis of the snowboard. The two configurations have different behaviors and a given rider may prefer one configuration at all times, or may change configurations for different riding conditions.

### BRIEF DESCRIPTION OF THE DRAWINGS

FIG. 1 is a perspective view of an exemplary embodiment of the mount of the present invention attached to a snowboard, which is partially cut away.

FIG. 2 is an exploded view of the mount of FIG. 1.

FIG. 3 is a back view of the mount of FIG. 1 with a typical boot binding attached.

FIG. 4 is a back view of an alternative embodiment of the mount with a typical binding attached.

FIG. 5 is a top view of a snowboard with a pair of mounts attached in an exemplary orientation, showing the outline of the rider's boots.

FIG. 6 is a top view of a snowboard with a pair of mounts attached in an alternative orientation, showing the outline of the rider's boots.

FIG. 7 is a side perspective view of the mount of FIG. 1, depicting a locking mechanism in the locked position.

FIG. 8 is a side perspective view of the mount of FIG. 1, showing the locking mechanism of FIG. 7 in the unlocked position.

### DETAILED DESCRIPTION OF THE INVENTION

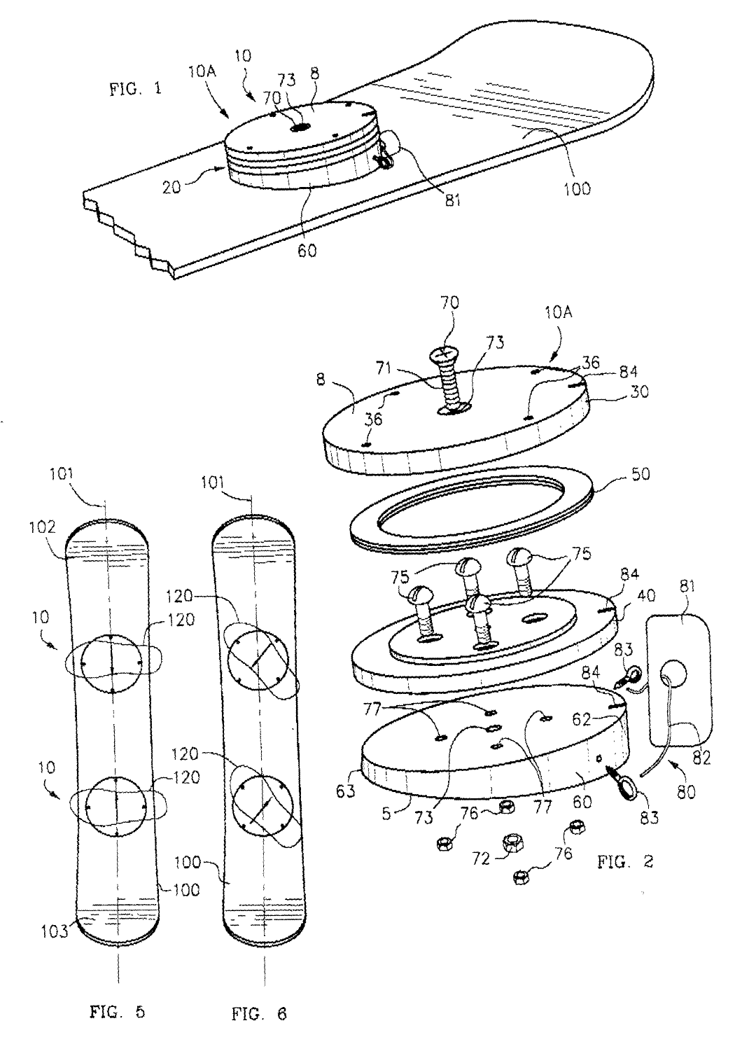

FIG. 1 is a perspective view of an exemplary embodiment 10A of mount 10 of the present invention attached to a snowboard 100, shown partially cut away. The upper face 8 of mount 10A serves as a mounting plane for attachment of a binding. Typically, a pair of mounts 10 are mounted on snowboard 100, each with one binding attached. Mount 10 includes swivel assembly 20 and cant means, such as cant disk 60.

FIG. 2 is an exploded view of mount 10A of FIG. 1. Swivel assembly 20 includes first plate 30, second plate 40, and bearing 50 between first plate 30 and second plate 40. Bearing 50 allows first plate 30 and second plate 40 to swivel completely freely relative to each other. A swivel connector 70, such as bolt 71 and nut 72, connects first plate 30, bearing 50, and second plate 40 in a stack. Bolt 71 passes through holes at the centers of first plate 30, bearing 50, and second plate 40 and is retained by nut 72. Although in embodiment 10A, swivel assembly 20 includes first plate 30, second plate 40, and bearing 50, which can be disassembled, swivel assembly 20 in its entirety can be considered as constituting a bearing; first plate 30 being part of the upper race of the bearing and second plate 40 being part of the lower race of the bearing. Alternatively, the swivel assembly could be considered as comprising a lower portion, comprising the lower race and all parts below; and an upper portion, comprising the upper race and all parts above, freely swivelable relative to the lower portion about a swivel, or bearing, axis.

Cant disk 60 is a disk of generally the same diameter as first plate 30 and second plate 40. The thickness of cant disk 60 decreases linearly across the diameter of cant disk 60, from thickest part 62 to thinnest part 63. In mount 10A, cant disk 60 is disposed below swivel assembly 20. Swivel attach screws 75 attach swivel assembly 20 to cant disk 60 and pass through holes in cant disk 60, retained by nuts 76. Nuts 76 are disposed within recesses cut into lower face 5 such that nuts 76 do not project below lower face 5 of mount 10A.

Although cant means 55 is herein illustrated as a separate cant disk 60, cant means 55 could equally well be an integral part of swivel assembly 20. For example, either first plate 30 or second plate 40 could have a thickness decreasing across the diameter of swivel assembly 20. By extension, cant means 55 could be considered as part of bearing 50, in the broader sense discussed above. Other cant means 55 include stand-offs for mounting screws or other attachment screws.

Mount 10 is attached to snowboard 100 with lower face 5 against the top deck of snowboard 100. Snowboards 100 typically have predrilled holes for mounting a conventional binding. Mount 10 is attached to snowboard 100 with screws 75 that pass through the appropriate holes 77 in lower face 5 and into the existing holes in snowboard 100. Mount 10 preferably includes predrilled holes of both patterns in upper face 8 and lower face 5.

Similarly, upper face 8 is attached to a binding by screws (not shown) that pass through holes in the binding and into mating holes 36 in upper face 8. Upper face 8 preferably includes predrilled holes in both the square and the triangle pattern typically found on bindings.

Lock means 80, such as lock means 80A, prevents swivel assembly 20 from swiveling when lock means 80 is engaged. Lock means 80A comprises a thin tab 81 attached by a flexible cable 82 to a pair of eyelet screws 83 attached to cant disk 60. Cant disk 60, first plate 30, and second plate 40 each include a vertical slot 84, adapted to allow tab 81 to fit snugly within.

FIGS. 7 and 8 are perspective side views of mount 10A. In FIG. 7, lock means 80A is in the locked position with tab 81 locking first plate 30 from swiveling relative to second plate 40. In FIG. 8, lock means 80A is in the unlocked position. Tab 81 has been removed from slot 84 in first plate 30, allowing first plate 30 to swivel freely. Cable 82 attaches tab 81 to mount 10A in both locked and unlocked positions. Tab 81 is positioned as desired with cable 82 slack. Turning either or both of eyelet screws 83 clockwise wraps cable 82 around the shank of the screw(s) 83 and tautens cable 82. When cable 82 is taut, tab 81 is fixed in its position. To change the position of tab 81, screw(s) 83 are turned counterclockwise to slacken cable 82. Other lock means 80 are contemplated but not illustrated, such as a vertical pin that passes through holes in first plate 30 and second plate 40. Lock means 80 is mainly intended for use by beginning snowboarders.

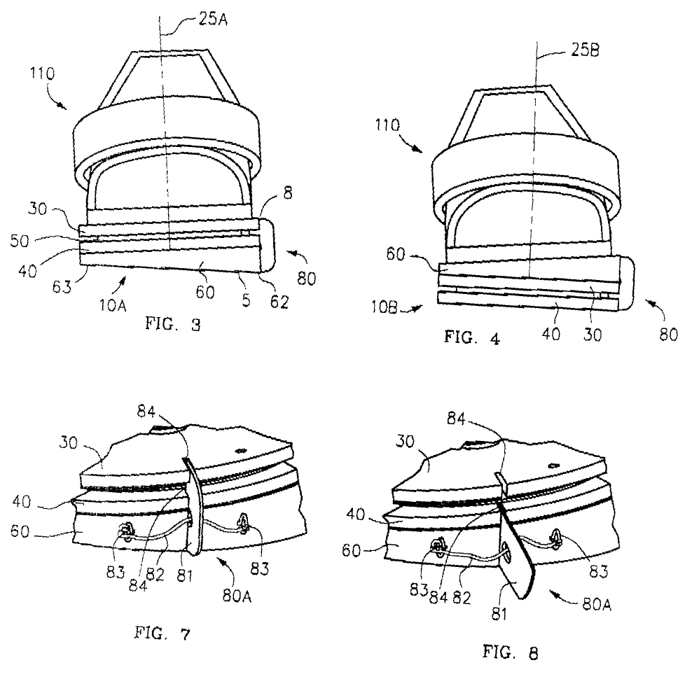

FIG. 3 is a back view of mount 10A with an exemplary binding 110 attached to upper surface 8. Mount 10A includes cant disk 60 disposed below swivel assembly 20, such that swivel assembly 20 has a swivel axis 25A that is not normal to the plane of snowboard 100 and generally parallel to the rider's leg when standing erect.

FIG. 4 is a back view of an alternative embodiment of mount 10, mount 10B, which includes cant disk 60 disposed above swivel assembly 20, such that swivel assembly 20 has a swivel axis 25B that is normal to the plane of snowboard 100, and not normal to the mounting plane. Swivel axis 25B is not generally parallel to the rider's leg when standing erect.

The alternative embodiments, 10A, 10B, each provide the rider with a different riding behavior of snowboard 100, which may be understood with reference to FIG. 5.

FIG. 5 is a top view of a pair of mounts 10 attached to snowboard 100. The outlines of the rider's boots 120 are superimposed. The arrows indicate the orientation of the cant, pointing toward thinnest (lowest) part 63. Boots 120 are generally transverse snowboard 100 (perpendicular to longitudinal axis 101) and canted toward each other. This may be called a “neutral stance,” which the rider would use to move forward down a moderate slope. The rider's weight is centered over longitudinal axis 101, midway between the two mounts 10. This stance is appropriate for a rider making frequent sharp turns.

Canting boots 120 toward each other decreases stress on the rider's ankles. Typically, a person's legs are parallel and vertical when standing with the feet together. A person standing with the feet about 18 inches apart, as is typical when riding a snowboard 100, has legs that are not vertical, but are angled toward each other. If boots 120 were attached to snowboard 100 with the soles parallel to the deck of snowboard 100, the ankles would be bent uncomfortably to connect the flat feet to the angled legs. A main purpose of cant disk 60 is to compensate for the angle of the legs, allowing the ankles to be straight in the neutral stance.

If mounts 10 of FIG. 5 are mounts 10A, then when the rider swivels mounts 10A, such as by pointing the toes of both boots 120 toward the nose 102 of snowboard 100, the cant orientation relative to snowboard 100 remains as shown by the arrows. In this toes-forward stance, the toes of boots 120 are canted “uphill” from the heels. Boots 120 are no longer canted toward one another, but rider's weight remains centered over longitudinal axis 102.

If mounts 10 of FIG. 5 are mounts 10B, the neutral stance is identical to that described above for mount 10A. However, when the rider swivels mounts 10B to a toesforward stance, each boot 120 remains canted as it was in the neutral stance. However, because swivel axis 25B is not generally parallel to the rider's leg, the rider's center of gravity is shifted to one side of longitudinal axis 101.

Mount 10B might be preferred by a highly skilled rider who frequently reverses the direction of travel by swiveling to face either nose 102 or tail 103 of board 100. Even when the rider changes stance by 180°, boots 120 remain canted toward each other and the legs are in the comfortable “A” posture. However, a less skilled rider might be inconvenienced by the shifting of his or her center of gravity across longitudinal axis 101.

FIG. 6 is a top view of a pair of mounts 10 attached to snowboard 100 in an alternative orientation. The outlines of the rider's boots 120 are superimposed. The arrows indicate the orientation of the cant, pointing toward thinnest part 63. The toes of boots 120 are pointing somewhat toward nose 102 in the neutral stance. Boots 120 are not canted toward each other, but are each canted toward longitudinal axis 101. The rider's center of gravity is over longitudinal axis 101. With mounts 10 mounted to snowboard 100 as shown 20, in FIG. 6, the rider finds it easier to shift the center of gravity toward nose 102 than with the orientation of FIG. 5. This stance is appropriate for a rider who wishes to maximize downhill speed by tucking into an aerodynamic crouch with the center of gravity closer to nose 102, but centered over longitudinal axis 101.

Although particular embodiments of the invention have been illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.

I claim:

1. A mount for attaching a boot binding to a snowboard or for supporting a rider's boot; the snowboard having a top and defining a plane; said mount comprising:
a swivel assembly comprising:
a bearing including:
a lower portion adapted for attachment to the snowboard: and
an upper portion connected to said lower portion and freely swivelable relative thereto about a bearing axis; said upper portion including:
mounting plane means defining a mounting plane for mounting a boot binding or for supporting a rider's boot.

2. The mount of claim 1 wherein said lower portion includes:
cant means for supporting said bearing such that the bearing axis is not normal to the plane of the snowboard.

3. The mount of claim 1 wherein said upper portion includes:
cant means supporting said mounting plane means such that the mounting plane is not normal to the bearing axis.

4. The mount of claim 1 further including:
locking means for selectively preventing said upper portion from swiveling relative to said lower portion.

5. The mount of claim 4 wherein:
said locking means interlocks said upper and lower portions.

6. In combination:
a snowboard having a top and defining a plane;
a mount for attaching a boot binding to said snowboard or for supporting a rider's boot; said mount comprising:
a swivel assembly comprising:
a bearing including:
a lower portion attached to said top of said snowboard: and
an upper portion connected to said lower portion and freely swivelable relative thereto about a bearing axis; said upper portion including:
mounting plane means defining a mounting plane for mounting a boot binding or for supporting a boot.

7. The combination of claim 6 wherein said lower portion includes:
cant means for supporting said bearing such that the bearing axis is not normal to the plane of said snowboard.

8. The combination of claim 6 wherein said upper portion includes:
cant means supporting said mounting plane means such that the mounting plane is not normal to the bearing axis.

9. The combination of claim 6 further including:
locking means for selectively preventing said upper portion from swiveling relative to said lower portion.

10. The combination of claim 9 wherein:
said locking means interlocks said upper and said lower portions.

11. In combination:
a snowboard having a top and defining a plane;
a mount comprising:
a swivel assembly comprising:
a bearing including:
a lower portion attached to said snowboard: and
an upper portion connected to said lower portion and freely swivelable relative thereto about a bearing axis; said upper portion including:
mounting plane means defining a mounting plane; and
a boot binding mounted on said upper portion.

12. The combination of claim 11, wherein said boot binding is mounted on said mounting plane.

13. The combination of claim 11 wherein said lower portion includes:
cant means for supporting said bearing such that the bearing axis is not normal to the plane of said snowboard.

14. The combination of claim 11 wherein said upper portion includes:
cant means supporting said mounting plane means such that the mounting plane is not normal to the bearing axis.

15. The combination of claim 11 further including:
locking means for selectively preventing said upper portion from swiveling relative to said lower portion.

16. The combination of claim 15 wherein:
said locking means interlocks said upper and said lower portions.
